(19) United States
(12) Patent Application Publication
(10) Pub. No.: US 2023/0387454 A1
(43) Pub. Date: Nov. 30, 2023

(54) SOLID LITHIUM ION CONDUCTING MATERIAL CONTAINING YTTERBIUM AND PROCESS FOR PREPARATION THEREOF

(71) Applicants: BASF SE, Ludwigshafen am Rhein (DE); University of Waterloo, Waterloo (CA)

(72) Inventors: Linda Nazar, Waterloo (CA); Xiaohan Wu, Ludwigshafen (DE); Se Young Kim, Waterloo (CA)

(21) Appl. No.: 18/031,690

(22) PCT Filed: Oct. 14, 2021
(86) PCT No.: PCT/EP2021/078423

§ 371 Date: Apr. 13, 2023

(30) Foreign Application Priority Data
Oct. 16, 2020 (EP) 20202273.7

(51) Int. Cl. H01M 10/0562; C01G 25/00

(52) U.S. Cl. CPC H01M 10/0562; C01G 25/006; C01P 2002/72; C01P 2002/76; H01M 2300/008

(57) ABSTRACT

Described are a solid material which has ionic conductivity for lithium ions, a composite comprising said solid material and a cathode active material, a process for preparing said solid material, a use of said solid material as a solid electrolyte for an electrochemical cell, a solid structure selected from the group consisting of a cathode, an anode and a separator for an electrochemical cell comprising the solid material, and an electrochemical cell comprising such solid structure.

Described are a solid material which has ionic conductivity for lithium ions, a composite comprising said solid material and a cathode active material, a process for preparing said solid material, a use of said solid material as a solid electrolyte for an electrochemical cell, a solid structure selected from the group consisting of a cathode, an anode and a separator for an electrochemical cell comprising the solid material, and an electrochemical cell comprising such solid structure.

Due to the wide-spread use of all-solid-state lithium batteries, there is an increasing demand for solid state electrolytes having a high conductivity for lithium ions. An important class of such solid electrolytes are lithium transition metal halides.

US 2019/0088995 A1 discloses a solid electrolyte material represented by the compositional formula:

Li_{6-3z}Y_{z}X₆

where 0<z<2 is satisfied; and X represents Cl or Br. According to US 2019/0088995 A1, these materials exhibit ionic conductivities in the range of from 0.2*10⁻⁴ S/cm to 7.1*10⁻⁴ S/cm at around room temperature.

Further prior art is

### US 2020/328463 A1

Andreas Bohnsack et al, Zeitschrift für anorganische and allgemeine Chemie (Journal of Inorganic and General Chemistry) vol. 623, 1 Sep. 1997, pages 1067-1073 and 1352-1356.

There is an ongoing need for solid lithium ion conductors which exhibit suitable ionic conductivity for application as solid electrolyte in all-solid state lithium batteries as well as electrochemical oxidative stability up to 4 V vs. Li/Li⁺ or more, preferably up to 4.5 V vs. Li/Li⁺, in order to enable application of cathode active materials having a redox potential of 4 V or more vs. Li/Li⁺ (cathode active material of the “4 V class”), so that a high cell voltage is obtainable.

It is an objective of the present disclosure to provide a solid material which may be used as a solid electrolyte for an electrochemical cell. More specifically, it is an object of the present disclosure to provide a solid material which may be used as a solid electrolyte for an electrochemical cell, wherein the cathode of said electrochemical cell comprises a cathode active material having a redox potential of 4 V or more vs. Li/Li⁺.

In addition, there is provided a composite comprising said solid material and a cathode active material, a process for preparing said solid material, a use of said solid material as a solid electrolyte for an electrochemical cell, a solid structure selected from the group consisting of a cathode, an anode and a separator for an electrochemical cell comprising the solid material, and an electrochemical cell comprising such solid structure wherein said solid structure comprises said solid material.

According to a first aspect, there is provided a solid material having a composition according to general formula (I)

Li_{3-n*x}Yb₁₋ₓMₓX_{y} (I)
wherein
0.05≤x≤0.95;
5.8≤y≤6.2;
n is the difference between the valencies of M and Yb;
M is one or more selected from the group consisting of Ti, Zr, Hf, V, Nb and Ta;
X is one or more selected from the group consisting of halides and pseudohalides.

Since ytterbium is three-valent, n is 1 if M is four-valent (as it is the case for Ti, Zr and Hf), and n is 2 if M is five-valent (as it is the case for Ta, Nb and V).

The composition according to general formula (I) may be considered as a lithium transition metal halide resp. as a lithium transition metal pseudohalide.

As used herein, the term “pseudohalides” (also referred to as “pseudohalogenides”) denotes monovalent anions, which resemble halide anions with regard to their chemistry, and therefore can replace halide anions in a chemical compound without substantially changing the properties of such compound. The term “pseudohalide ion” is known in the art, cf. the IUPAC Goldbook. Examples of pseudohalide anions are N₃⁻, SCN⁻, CN⁻, OCN⁻, BF₄⁻ and BH₄⁻. In pseudohalide-containing solid materials of general formula (I) the pseudohalide anion is preferably selected from the group consisting of BF₄⁻ and BH₄⁻.

In halide-containing solid materials of general formula (I) the halide is preferably selected from the group consisting of Cl, Br and I.

Surprisingly it has been found that solid materials having a composition according to general formula (I) as defined above may exhibit favorable lithium ion conductivity as well as electrochemical oxidation stability in contact with a cathode active material having a redox potential of 4 V or more vs. Li/Li⁺, and also in contact with electron-conducting materials comprising or consisting of elemental carbon (e.g. carbon black, graphite) which are typical electrode additives in electrochemical cells. This is an important advantage over state-of-the-art solid electrolytes which contain sulfur.

A solid material according to the first aspect as defined herein may have a composition according to formula (I) wherein X is one or more halides selected from the group consisting of Cl, Br and I, preferably Cl.

A solid material according to the first aspect as defined herein may have a composition according to formula (I) wherein 0.08≤x≤0.85, preferably 0.1≤x≤0.8, more preferably 0.12≤x≤0.65, most preferably 0.15≤x≤0.6.

A solid material according to the first aspect as defined herein may have a composition according to formula (I) wherein 5.85≤y≤6.15, more preferably 5.9≤y≤6.1, most preferably 5.95≤y≤6.05.

More specifically, a solid material according to the first aspect as defined herein may have a composition according to formula (I) wherein 0.08 x 0.85, preferably 0.1≤x≤0.8, more preferably 0.12≤x≤0.65, most preferably 0.15≤x≤0.6, and wherein 5.85≤y≤6.15, more preferably 5.9≤y≤6.1, most preferably 5.95≤y≤6.05.

Further specifically, a solid material according to the first aspect as defined herein may have a composition according to formula (I) wherein
X is one or more halides selected from the group consisting of Cl, Br and I, preferably Cl; and
0.05≤x≤0.95, more specifically 0.08≤x≤0.85, preferably 0.1≤x≤0.8, more preferably 0.12≤x≤0.65, most preferably 0.15≤x≤0.6; and
5.8≤y≤6.2, more specifically 5.85≤y≤6.15, preferably 5.9≤y≤6.1, most preferably 5.95≤y≤6.05.

In certain cases, a solid material according to the first aspect as defined herein may be crystalline as detectable by the X-ray diffraction technique. A solid material is referred to as crystalline when it exhibits a long range order that is characteristic of a crystal, as indicated by the presence of clearly defined reflections in its X-ray diffraction pattern. In this context, a reflection is considered as clearly defined if its intensity is more than 10% above the background.

A solid material according to the above-defined first aspect may consist of a single phase or of more than one phase, e.g. a main phase (primary phase) and minor amounts of impurities and secondary phases. It is understood that formula (I) is an empirical formula (gross formula) as determinable by means of elemental analysis. Accordingly, formula (I) defines a composition which is averaged over all phases present in the solid material. However, a solid material according to the above-defined first aspect comprises at least one phase which as such has a composition according to formula (I). In case a crystalline solid material according to the above-defined first aspect contains more than one phase, than the weight fraction of phases which as such do not have a composition according to formula (I) (e.g. impurity phases, secondary phases) is so small that the composition averaged over all phases is according to formula (I). The total weight fraction of secondary phases and impurity phases may be 20% or less, preferably 10% or less, further preferably 5% or less, most preferably 3% or less, based on the total weight of the solid material.

If present, the secondary phases and impurity phases mainly consist of the precursors used for preparing the solid material, e.g. LiX and MX₃ (wherein X and M are as defined above), and sometimes impurity phases which may originate from impurities of the precursors. For details of preparing a solid material according to the above defined first aspect, see the information provided below in the context of the second aspect of the present disclosure.

In certain cases, a solid material according to the above-defined first aspect is in the form of a polycrystalline powder, or in the form of single crystals.

A crystalline solid material according to the first aspect as defined herein may comprise or consist of one or more crystalline phases having a structure selected from an orthorhombic structure in space group Pnma, and a trigonal structure in the space group P-3m1.

In certain cases, a solid material according to the first aspect as defined herein is glassy, i.e. amorphous. A solid material is referred to as amorphous when it lacks the long range order that is characteristic of a crystal, as indicated by the absence of clearly defined reflections in its X-ray diffraction pattern. In this context, a reflection is considered as clearly defined if its intensity is more than 10% above the background.

In certain cases, a solid material according to the first aspect as defined herein is glass-ceramics, i.e. a polycrystalline solid having at least 30% by volume of a glassy phase.

A first group of solid materials according to the first aspect as defined herein has a composition according to formula (I) wherein X is as defined above; and M is one or more of Ti, Zr and Hf. Since in a solid material of said first group M is a four-valent metal, n is 1. Thus, a solid material of said first group has a composition according to formula (Ia)

Li₃₋ₓYb₁₋ₓMₓX_{y} (Ia)
wherein
M is one or more selected from the group consisting of Ti, Zr, and Hf;
X is one or more selected from the group consisting of halides and pseudohalides;
0.05≤x≤0.95;
5.8≤y≤6.2.

A solid material of the above-defined first group may have a composition according to formula (Ia) wherein X is one or more halides selected from the group consisting of Cl, Br and I. Further specifically, a solid material of the above-defined first group may have a composition according to formula (Ia) wherein X is Cl.

A solid material of the above-defined first group may have a composition according to formula (Ia) wherein M is Zr. More specifically, a solid material of the above-defined first group may have a composition according to formula (Ia) wherein M is Zr and X is one or more halides selected from the group consisting of Cl, Br and I, preferably Cl.

A solid material of the above-defined first group may have a composition according to formula (Ia) wherein 0.08≤x≤0.85, preferably 0.1≤x≤0.8, more preferably 0.12≤x≤0.65, most preferably 0.15≤x≤0.6.

A solid material of the above-defined first group may have a composition according to formula (Ia) wherein 5.85≤y≤6.15, more preferably 5.9≤y≤6.1, most preferably 5.95≤y≤6.05.

More specifically, a solid material of the above-defined first group may have a composition according to formula (Ia) wherein 0.08≤x≤0.85, preferably 0.1≤x≤0.8, more preferably 0.12≤x≤0.65, most preferably 0.15≤x≤0.6, and wherein 5.85≤y≤6.15, more preferably 5.9≤y≤6.1, most preferably 5.95≤y≤6.05.

Specific solid materials of the above-defined first group may have a composition according to formula (Ia) wherein M is Zr, and X is Cl, wherein 0.05≤x≤0.95, more specifically 0.08≤x≤0.85, preferably 0.1≤x≤0.8, more preferably 0.12≤x≤0.65, most preferably 0.15≤x≤0.6, and wherein 5.8≤y≤6.2, more specifically 5.85≤y≤6.15, preferably 5.9≤y≤6.1, most preferably 5.95≤y≤6.05.

Solid materials according to formula (Ia) wherein M is Zr, X is Cl, x is <0.1 and y is as defined above for formula (Ia) exhibit a crystalline phase in the P-3m1 space group, like the parent compound Li₃YbCl₆. As more Yb³⁺ ions are substituted by Zr⁴⁺ ions (0.1≤x<0.3) a second crystalline phase emerges which has orthorhombic symmetry (Pnma space group). When x≥0.3 said second crystalline phase which has a different orthorhombic symmetry (Pnma space group) is mainly present.

A second group of solid materials according to the first aspect as defined herein has a composition according to formula (I) wherein X is as defined above; and M is one or more of V, Nb and Ta. Since in a solid material of said second group M is a five-valent metal, n is 2. Thus, a solid material of said second group has a composition according to formula (Ib)

Li₃₋₂ₓYb₁₋ₓMₓX_{y} (Ib)
wherein
M is one or more selected from the group consisting of V, Nb and Ta;
X is one or more selected from the group consisting of halides and pseudohalides;
0.05≤x≤0.95;
5.8≤y≤6.2.

A solid material of the above-defined second group may have a composition according to formula (Ib) wherein X is one or more halides selected from the group consisting of Cl, Br and I. Further specifically, a solid material of the above-defined second group may have a composition according to formula (Ib) wherein X is Cl.

A solid material of the above-defined second group may have a composition according to formula (Ib) wherein M is one or both of Nb and Ta. More specifically, a solid material of the above-defined second group may have a composition according to formula (Ib) wherein M is one or both of Nb and Ta, and X is one or more halides selected from the group consisting of Cl, Br and I, preferably Cl.

A solid material of the above-defined second group may have a composition according to formula (Ib) wherein 0.08≤x≤0.85, preferably 0.1≤x≤0.8, more preferably 5.95≤x≤0.65, most preferably 0.15≤x≤0.6.

A solid material of the above-defined second group may have a composition according to formula (Ib) wherein 5.85≤y≤6.15, more preferably 5.9≤y≤6.1, most preferably 5.95≤y≤6.05.

More specifically, a solid material of the above-defined second group may have a composition according to formula (Ib) wherein 0.08≤x≤0.85, preferably 0.1≤x≤0.8, more preferably 0.12≤x≤0.65, most preferably 0.15≤x≤0.6, and wherein 5.85≤y≤6.15, more preferably 5.9≤y≤6.1, most preferably 5.95≤y≤6.05.

Specific solid materials of the above-defined second group may have a composition according to formula (Ib) wherein M is Nb or Ta, X is Cl, wherein 0.05≤x≤0.95, more specifically 0.08≤x≤0.85, preferably 0.1≤x≤0.8, more preferably 0.12≤x≤0.65, most preferably 0.15≤x≤0.6, and wherein 5.8≤y≤6.2, more specifically 5.85≤y≤6.15, preferably 5.9≤y≤6.1, most preferably 5.95≤y≤6.05.

A solid material according to the first aspect as defined herein may have an ionic conductivity of 0.1 mS/cm or more, preferably 0.5 S/cm or more, more preferably 1 mS/cm or more, in each case at a temperature of 25° C. The ionic conductivity is determined in the usual manner known in the field of solid state battery materials development by means of electrochemical impedance spectroscopy (for details see examples section below).

At the same time, a solid material according to the first aspect as defined herein may have an almost negligible electronic conductivity. More specifically, the electronic conductivity may be at least 3 orders of magnitude lower than the ionic conductivity, preferably at least 5 orders of magnitude lower than the ionic conductivity. In certain cases, a solid material according to the first aspect as defined herein exhibits an electronic conductivity of 10⁻¹⁰ S/cm or less. The electronic conductivity is determined in the usual manner known in the field of battery materials development by means of direct-current (DC) polarization measurements at different voltages.

Preferred solid materials according to the first aspect as defined herein are those having one or more of the specific and preferred features disclosed above.

According to a second aspect, there is provided a process for obtaining a solid material according to the above-defined first aspect. Said process comprises the following process steps:
(a) providing the precursors
   (1) one or more compounds selected from the group consisting of halides and pseudohalides of Li;
   (2) one or more compounds selected from the group consisting of halides and pseudohalides of Yb;
   (3) one or more compounds selected from the group consisting of halides and pseudohalides of elements M selected from the group consisting of Ti, Zr, Hf, V, Nb and Ta;
   wherein in said reaction mixture the molar ratio of Li, Yb, M, halides and pseudohalides matches general formula (I)
(b) reacting the precursors to obtain a solid material having a composition according to general formula (I).

In step a) of the process according to the above-defined second aspect, a reaction mixture comprising precursors for the reaction product to be formed in step b) is provided. Said precursors are
(1) one or more compounds LiX; and
(2) one or more compounds YbX₃; and
(3) one or more compounds selected from the group consisting of
   compounds MX₄ wherein M is selected from the group consisting of Ti, Zr and Hf; and
   compounds MX₅ wherein M is selected from the group consisting of V, Nb and Ta;
wherein in each of precursors (1) to (3), independently from the other precursors, X is one or more selected from the group consisting of halides and pseudohalides;
wherein the molar ratio of Li, Yb, M and X matches general formula (I).

Preferably, the reaction mixture consists of the above-defined precursors (1), (2) and (3).

In certain cases, in each of precursors (1) to (3), independently from the other precursors, X is one or more selected from the group consisting of Cl, Br and I. Preferably in each of precursors (1) to (3) X is the same, preferably Cl.

In certain processes according to the above-defined second aspect, the precursor (3) is one or more compounds from the group consisting of compounds MX₄ wherein M is selected from the group consisting of Ti, Zr and Hf, and X is as defined above. Such processes are suitable for preparing solid materials having a composition according to general formula (Ia) as defined above.

Thus, suitable precursors for a solid material having a composition according to general formula (Ia) are
(1) one or more compounds LiX; and
(2) one or more compounds YbX₃; and
(3) one or more compounds from the group consisting of compounds MX₄ wherein M is selected from the group consisting of Ti, Zr and Hf, preferably Zr;
wherein in each of precursors (1) to (3), independently from the other precursors, X is one or more selected from the group consisting of halides and pseudohalides;
wherein the molar ratio of Li, Yb, M and X matches general formula (Ia).

Preferably, the reaction mixture consists of the above-defined precursors (1), (2) and (3).

In certain cases, in each of precursors (1) to (3), independently from the other precursors, X is one or more selected from the group consisting of Cl, Br and I. Preferably in each of precursors (1) to (3) X is the same, preferably Cl.

In certain cases, in precursor (3) M is Zr.

In specific cases, in each of precursors (1) to (3), independently from the other precursors, X is one or more selected from the group consisting of Cl, Br and I, and in precursor (3) M is Zr. Further specifically, in each of precursors (1) to (3), X is Cl and in precursor (3) M is Zr.

In certain processes according to the above-defined second aspect, the precursor (3) is one or more compounds selected from the group consisting of compounds MX₅ wherein M is selected from the group consisting of V, Nb and Ta, and X is as defined above. Such processes are suitable for preparing solid materials having a composition according to general formula (Ib) as defined above.

Thus, suitable precursors for a solid material having a composition according to general formula (Ib) are
(1) one or more compounds LiX; and
(2) one or more compounds YbX₃; and
(3) one or more compounds from the group consisting of compounds MX₅ wherein M is selected from the group consisting of V, Nb and Ta;
wherein in each of precursors (1) to (3), independently from the other precursors, X is one or more selected from the group consisting of halides and pseudohalides;
wherein the molar ratio of Li, Yb, M and X matches general formula (Ib).

Preferably, the reaction mixture consists of the above-defined precursors (1), (2) and (3).

In certain cases, in each of precursors (1) to (3), independently from the other precursors, X is one or more selected from the group consisting of Cl, Br and I. Preferably in each of precursors (1) to (3) X is the same, preferably Cl.

In certain cases, in precursor (3) M is one or both of Nb and Ta.

In specific cases, in each of precursors (1) to (3), independently from the other precursors, X is one or more selected from the group consisting of Cl, Br and I, and in precursor (3) M is Ta or Nb. Further specifically, in each of precursors (1) to (3), X is Cl and in precursor (3) M is Ta or Nb.

The process according to the above-defined second aspect may be a thermochemical solid-state process or a solution-based process (solution-based synthesis).

A thermochemical solid state process according to the above-defined second aspect comprises the steps
(a1) preparing or providing a solid reaction mixture comprising the precursors (1), (2) and (3)
(b1) heat-treating the reaction mixture in a temperature range of from 300° C. to 650° C. for a total duration of from 5 hours to 50 hours so that a reaction product is formed and cooling the reaction product so that a solid material having a composition according to general formula (I) is obtained.

In step (a1) of the above-defined thermochemical solid state process, the solid reaction mixture may be obtained by mixing the precursors. Mixing the precursors may be performed by means of grinding the precursors together. Grinding can be done using any suitable means.

The reaction mixture which is prepared or provided in step (a1) may be formed into pellets, which are heat-treated in step (b1). Then, a solid material in the form of pellets or chunks is obtained, which may be ground into powder for further processing.

It is useful that in step (a1) any handling is performed under a protective gas atmosphere.

In step (b1) of the process according to the above-defined second aspect, the reaction mixture is allowed to react so that a solid material having a composition according to general formula (I) is obtained. In other words, in step (b1) the precursors in the reaction mixture react with each other to obtain a solid material having a composition according to general formula (I).

The reaction mixture prepared in process step (a1) is heat-treated in step (b1) to enable the reaction of the precursors. Said reaction is considered to be substantially a solid state reaction, i.e. it occurs with the reaction mixture in the solid state.

Heat-treating may be performed in a closed vessel. The closed vessel may be a sealed quartz tube or any other type of container which is capable of withstanding the temperature of the heat treatment and is not subject to reaction with any of the precursors, such as a glassy carbon crucible or a tantalum crucible.

In step (b1) the reaction mixture may be heat-treated in a temperature range of from 300° C. to 650° C. for a total duration of 5 hours to 50 hours so that a reaction product is formed. More specifically, in step (b1) the reaction mixture may be heat-treated in a temperature range of 350° C. to 650° C. for a total duration of 5 hours to 15 hours. The heat treatment in step (b1) may be carried out under vacuum or under a protective gas atmosphere.

When the duration of the heat treatment of step (b1) is completed, the formed reaction product is allowed to cool down. Thus, a solid material having a composition according to general formula (I) is obtained. Cooling of the reaction product is preferably performed using a cooling rate of 1 to 10° C. per minute.

A solution-based process according to the above-defined second aspect comprises the steps
(a2) preparing or providing a liquid reaction mixture by dissolving the precursors (1), (2) and (3) in a solvent selected from the group consisting of ethers, H₂O, alcohols CₙH₂ₙ₊₁OH wherein 1≤n≤20, formic acid, acetic acid, dimethylformamide, N-methylformamide, pyridine, nitriles, N-methylpyrrolidinone, dimethyl sulfoxide, acetone, ethyl acetate, dimethoxyethane, 1,3-dioxolane, and alkylene carbonates;
(b2) removing the solvents from the liquid reaction mixture, so that a solid residue is obtained, and heat-treating the solid residue in a temperature range of from 100° C. to 300° C. for a total duration of 4 hours to 24 hours so that a reaction product is formed and cooling the reaction product so that a solid material having a composition according to general formula (I) is obtained.

In step (a2) of the solution-based process a liquid reaction mixture is prepared by dissolving the above-mentioned precursors (1), (2) and (3) in a solvent selected from the group consisting of ethers, H₂O, alcohols CₙH₂ₙ₊₁OH (1≤n≤20), formic acid, acetic acid, dimethylformamide, N-methylformamide, pyridine, nitriles, dimethyl sulfoxide, acetone, ethyl acetate, dimethoxyethane, 1,3-dioxolane, N-methylpyrrolidinone, and alkylene carbonates. Mixtures of two or more solvents selected from said group are also possible. Preferred solvents are ethers, alcohols with 1≤n 6≤and pyridine.

The liquid reaction mixture prepared in step (a2) of the solution-based process is in the form of a solution of the above-defined precursors (1), (2) and (3) in a solvent selected from the group consisting of ethers, H₂O, alcohols CₙH₂ₙ₊₁OH (1≤n≤20), formic acid, acetic acid, dimethylformamide, N-methylformamide, pyridine, nitriles, dimethyl sulfoxide, acetone, ethyl acetate, dimethoxyethane, 1,3-dioxolane, N-methylpyrrolidinone, and alkylene carbonates. Mixtures of two or more solvents selected from said group are also possible. Preferred solvents are ethers, alcohols CₙH₂ₙ₊₁OH with 1≤n≤6 and pyridine.

The total content of precursors (1), (2) and (3) in the liquid reaction mixture prepared in step (a2) of the solution-based process is in the range from 1% to 80%, and preferably in the range from 3% to 30%, based on the total weight of the liquid reaction mixture (sum of the weights of all precursors and solvents).

The solution-based process does not involve mechanochemical milling (i.e. reactive-milling) of the precursors (1), (2) and (3) resp. of a mixture thereof.

It is presently assumed that solution-based synthesis according to the process described herein provides an intimate mix of the precursors, potentially reducing the temperature and/or duration of the subsequent heat treatment in step (b2) of the solution-based process, compared to the heat treatment to be applied in purely thermochemical synthesis of corresponding materials.

In step (a2) of the solution-based process preferably any handling is performed under a protective gas atmosphere.

In step (b2) of the solution-based process, the liquid reaction mixture is transferred into a solid material according to general formula (I) by removing the solvents do that a solid residue is obtained, and subsequent heat treatment (sintering) of the solid residue.

In step (b2) of the solution-based process removal of the solvents is preferably achieved by subjecting the solution to a reduced pressure (relative to standard pressure 101.325 kPa) at a temperature in the range from 0° C. to 100° C., preferably from 20° C. to 40° C. under dynamic vacuum (continuous removal of the vapor of the solvent from the reaction vessel).

In step (b2) of the solution-based process, after removal of the solvents, heat treatment of the obtained residue is preferably performed in a closed vessel for a duration of 1 to 12 hours, more preferably 4 to 8 hours, at a temperature in the range of from 100° C. up to 300° C., further preferably in the range of from 100° C. to 250° C., most preferably in the range of from 100° C. to 200° C.

The heat treatment in step (b2) of the solution-based process is carried out either under vacuum or under a protective gas atmosphere.

If necessary, the solid material obtained by the solution-based process according to the invention as described above is ground into a powder.

Preferred processes according to the second aspect as defined herein are those having one or more of the specific features disclosed above.

According to a third aspect, there is provided a composite comprising
a solid material according to the above-defined first aspect resp. obtained by a process according to the above-defined second aspect
and a cathode active material.

In the context of the present disclosure, the electrode of an electrochemical cell where during discharging of the cell a net positive charge occurs is called the cathode, and the component of the cathode by reduction of which said net positive charge is generated is referred to as a “cathode active material”.

In the above defined composite, the solid material according to the above-defined first aspect resp. obtained by a process according to the above-defined second aspect acts as a solid electrolyte which is conductive for Li⁺ ions (lithium ions).

Preferred cathode active materials are those having a redox potential of 4 V or more vs. Li/Li⁺ (cathode active material of the “4 V class”), which enable obtaining a high cell voltage. A couple of such cathode active materials is known in the art.

Preferred cathode active materials are selected from the group consisting of materials having a composition according to general formula (II)

Li₁₊ₜ[CoₓMn_{y}Ni_{z}Mᵤ]₁₋ₜO₂ (II)
wherein
0≤x≤1
0≤y≤1
0≤z≤1
0≤u≤0.15

M if present is one or more elements selected from the group consisting of Al, Mg, Ba, B, and transition metals other than Ni, Co, and Mn,
x+y+z>0
x+y+z+u=1
−0.05≤t≤0.2.

In certain cathode active materials according to formula (II), M may be one of Al, Mg, Ti, Mo, Nb, W and Zr. Exemplary cathode active materials of formula (II) are Li₁₊ₜ[Ni_{0.88}Co_{0.08}Al_{0.04}]₁₋ₜO₂, Li₁₊ₜ[Ni_{0.905}Co_{0.0475}Al_{0.0475}]₁₋ₜO₂, and Li₁₊ₜ[Ni_{0.91}Co_{0.045}Al_{0.045}]₁₋ₜO₂, wherein in each case −0.05≤t≤0.2.

Suitable cathode active materials are e.g. oxides comprising lithium and one or more members of the group consisting of nickel, cobalt and manganese. Those cathode active materials have a composition according to general formula (IIa):

Li₁₊ₜ[CoₓMn_{y}Ni_{z}]₁₋ₜO₂ (IIa)
wherein
0≤x≤1
0≤y≤1
0≤z≤1
x+y+z=1
−0.05≤t≤0.2.

Preferably the cathode active material according to general formula (IIa) is a mixed oxide of lithium and at least one of nickel and manganese. More preferably, the cathode active material is a mixed oxide of lithium, nickel and one or both members of the group consisting of cobalt and manganese.

Exemplary cathode active materials according to formula (IIa) are LiCoO₂, Li₁₊ₜ[Ni_{0.87}Co_{0.10}Mn_{0.05}]₁₋ₜO₂, Li₁₊ₜ[Ni_{0.87}Co_{0.05}Mn_{0.08}]₁₋ₜO₂, Li₁₊ₜ[Ni_{0.83}Co_{0.12}Mn_{0.05}]₁₋ₜO₂, and Li₁₊ₜ[Ni_{0.6}Co_{0.2}Mn_{0.2}]₁₋ₜO₂ (NCM622) and LiNi_{0.5}Mn_{1.5}O₄, wherein in each case −0.05≤t≤0.2.

Exemplary cathode active materials which may be used in combination with the solid material according to the above-defined first aspect are compounds of formula (IIb):

Li₊ₜA₁₋ₜO₂ (IIb),
wherein
A comprises nickel
and one or both members of the group consisting of cobalt and manganese, and optionally
   one or more further transition metals not selected from the group consisting of nickel, cobalt and manganese, wherein said further transition metals are preferably selected from the group consisting of molybdenum, titanium, tungsten, zirconium,
   one or more elements selected from the group consisting of aluminum, barium, boron and magnesium,
wherein at least 50 mole-% of the transition metal of A is nickel;
t is a number in the range of from −0.05 to 0.2.

Suitable cathode active materials having a composition according to formula (IIb) are described in WO 2020/249659 A1.

Exemplary cathode active materials of formula (IIb) which may be used in combination with the solid material according to the above-defined first aspect are Li₁₊ₜ[Ni_{0.85}Co_{0.10}Mn_{0.05}]₁₋ₜO₂, Li₁₊ₜ[Ni_{0.87}Co_{0.05}Mn_{0.08}]₁₋₋ₜO₂, Li₁₊ₜ[Ni_{0.83}Co_{0.12}Mn_{0.05}]₁₋ₜO₂, Li₁₊ₜ[Ni_{0.6}Co_{0.2}Mn_{0.2}]₁₋ₜO₂, Li₁₊ₜ[Ni_{0.88}Co_{0.08}Al_{0.04}]₁₋ₜO₂, Li₁₊ₜ[Ni_{0.905}Co_{0.0475}Al_{0.0475}]^{1--t}O₂, and Li₁₊ₜ[Ni_{0.91}Co_{0.045}Al_{0.045}]₁₋₋ₜO₂, wherein in each case 31 0.05≤t≤0.2.

In the above defined composite, a cathode active material and a solid material according to the above-defined first aspect may be admixed with each other. More specifically, in a composite according to the third aspect as defined herein, a cathode active material and a solid material according to the above-defined first aspect may be admixed with each other and with one or more binding agents and/or with one or more electron-conducting materials. Typical electron-conducting materials are those comprising or consisting of elemental carbon, e.g. carbon black, graphite and carbon nanofibers. Typical binding agents are poly(vinylidenefluroride) (PVDF), styrene-butadiene rubber (SBR), polyisobutene, poly(ethylene vinyl acetate), poly(acrylonitrile butadiene).

A composite as defined herein may be in the form of a coated particulate material. Said coated particulate material comprises
C1) a plurality of core particles, each core particle comprising at least one cathode active material; and
C2) disposed on the surfaces of the core particles, a coating comprising
   carbonate anions,
   and at least one solid material having a composition according to general formula (I) as defined above.

In the coated particulate material, the coating C2) is disposed on the surfaces of at least a part of the core particles C1), preferably it is disposed on the surfaces of >50% of the total number of core particles C1), more preferably on the surfaces of ≥75% of the total number of core particles C1), even more preferably on the surfaces of ≥90% of the total number of core particles C1) and yet even more preferably on the surfaces of ≥95% of the total number of core particles C1) present in the coated particulate material. For the purposes of the present disclosure, the part of the core particles C1) on whose surfaces the coating C2) is disposed can be determined by electron microscopy performed on a representative sample of the coated particulate material.

In the coated particulate material ac, the coating C2) is disposed on at least a part of the surface of a (an individual) core particle C1), preferably it is disposed on >50% of the total surface of a core particle C1), more preferably on ≥75% of the total surface of a core particle C1) and even more preferably on ≥90% of the total surface of a core particle C1). For the purposes of the present disclosure, the part of the surface of a core particle C1) on which the coating C2) is disposed can be determined by electron microscopy performed on a (representative) sample of an (individual) coated particle of the coated particulate material or a (representative) sample of the coated particulate material.

In the coated particulate material, the lithium present in the coating C2) is preferably present as part of solid materials having a composition according to general formula (I) as described above and of lithium carbonate (Li₂CO₃). Preferably, the total amount of lithium present in the coating C2) is present as part of solid materials having a composition according to general formula (I) as described above and of lithium carbonate (Li₂CO₃).

In the coated particulate material, the coating C2) may comprise carbonate anions in a total amount of ≥0.12%, or of ≥0.15%, in each case relative to the total mass of the plurality of uncoated core particles C1). More specifically, the coating C2) may comprise carbonate anions in a total amount in the range of from 0.12% to 3.0%, preferably of from 0.15% to 2.5%, more preferably of from 0.15% to 2.0%, even more preferably of from 0.15% to 1.0%, relative to the total mass of the plurality of uncoated core particles C1). If the content of lithium carbonate in the coating C2) is too high, the lithium ion conductivity may be decreased.

Without wishing to be bound by any theory, it is presently assumed that the carbonate present on the surface of the core particles C1) originates from unavoidable impurities of the cathode active material which may be formed when the cathode active material is prepared or stored in the presence of traces of carbon dioxide and humidity, and/or in certain cases from using lithium carbonate as a precursor for the synthesis of the cathode active material, and/or from the decomposition of the organic solvent of the liquid reaction mixture used in preparing the coated particulate material (for details see below) in air resp. oxygen and reactivity with residual lithium on the particle surface of the cathode active material.

In the coated particulate material described herein, at least a part of the carbonate ions present in the coating C2) may be present as part of an ionic compound, e.g. as part of a salt. Herein, at least a part of the carbonate ions present in the coating C2), preferably the total amount of carbonate ions present in the coating C2), is present as lithium carbonate.

For the purposes of the present disclosure, the amount of carbonate ions present in the coating C2) may be determined by acid titration, coupled with mass spectroscopy, more preferably according to the method as defined in the examples section of WO 2020/249659 A1, performed on a representative sample of the coated particulate material.

The thickness of the coating C2) may be in the range of from 1 nm to 1 μm, preferably of from 1 nm to 50 nm.

In certain cases, a coated particulate material as described herein comprises or consist of
C1) a plurality of core particles, each core particle comprising at least one cathode active material, preferably at least one cathode active material having a composition according to general formula (II) as defined above; and
C2) disposed on the surfaces of the core particles, a coating comprising
   carbonate anions, preferably lithium carbonate;
   and at least one solid material having a composition according to general formula (I) as defined above, preferably according to general formula (Ia) as defined above.

A process for preparing a coated particulate material as defined above comprises the steps
(i) preparing or providing a liquid reaction mixture as in step (a2) of the solution-based process described above in the context of the second aspect,
(ii) preparing or providing a plurality of core particles C1), each core particle comprising at least one cathode active material,
(iii) contacting the core particles C1) and the liquid reaction mixture with each other
(iv) removing the solvents of the liquid reaction mixture, so that a solid residue is obtained, and heat-treating the solid residue in a temperature range of from 100° C. to 300° C. for a total duration of 4 hours to 12 hours
   so that a coated particulate material as defined above results.

Preparation of a liquid reaction mixture (step (i)) is carried out as disclosed above in the context of the solution-based process of the second aspect. Regarding preferred and specific precursors for the preparation of a liquid reaction mixture, reference is made to the disclosure provided above in the context of the second aspect of the present disclosure. Regarding preferred and specific solvents for the preparation of a liquid reaction mixture, reference is made to the disclosure provided above for solution-based processes of the second aspect of the present disclosure.

Methods for preparing core particles C1) comprising at least one cathode active material (step (ii)), preferably consisting of at least one cathode active material, are known in the art. Core particles C1) comprising or consisting of at least one cathode active material are commercially available. For preferred and specific cathode active materials see above.

In step (iii) of the process for preparing a coated particulate material as defined above, the core particles C1) and the liquid reaction mixture can be contacted with each other by means of any suitable technique, e.g. by mixing and/or spraying. For enhanced or completed contact, e.g. for finalizing the preparation of a mixture or a gel, sonicating may be used, preferably at a temperature in the range of from 15° C. to 30° C. and for a time period in the range of from 15 min to 60 min.

In step (iv) of the process for preparing a coated particulate material as defined above, removal of the solvents of the liquid reaction mixture (as prepared in step (i)) is preferably achieved by subjecting the solution to a reduced pressure (relative to standard pressure 101.325 kPa) at a temperature in the range of from 0° C. to 100° C., preferably of from 20° C. to 40° C.

In step (iv) heat treating the solid residue may comprise calcining the solid residue. Heat treatment in step (iv) may be carried out in the presence of carbon dioxide, oxygen, air, nitrogen, N₂O or argon.

In step (iv), the solid residue may be ground prior to the heat treatment.

It is understood that the process for preparing a coated particulate material as defined above may be considered as a combination of solution-based synthesis (as described above in the context of the second aspect of the present disclosure) of a solid material having a composition according to general formula (I) and coating core particles C1) comprising a cathode active material with a coating C2) comprising said solid material having a composition according to general formula (I) obtained by solution-based synthesis. In other words, in the process for preparing a coated particulate material as defined above the solution-based synthesis (as described above in the context of the second aspect of the present disclosure) of a solid material having a composition according to general formula (I) is carried out in the presence of core particles C1) comprising a cathode active material in the liquid reaction mixture. Thus, solution-based synthesis (as described above in the context of the second aspect of the present disclosure) of a solid material having a composition according to general formula (I) enables direct formation of such solid material as part of a coating C2) on core particles C1) comprising a cathode active material.

A composite according to the third aspect as defined above may be used for preparing a cathode for an electrochemical cell.

A composite according to the third aspect as defined above may be used in a cathode for an electrochemical cell.

Due to its superior electrochemical oxidative stability, a solid material according to the first aspect of the present disclosure (as defined above) may be applied as a solid electrolyte in direct contact with a cathode active material having a redox potential of 4 V or more, preferably of 4.5 V or more vs. Li/Li⁺. Substantially no oxidative side reaction of the solid electrolyte occurs during discharging of the cathode active material.

This is an important advantage because it may become possible to apply electrochemical cell configurations wherein the cathode active material is in direct contact with a solid electrolyte in the form of a solid material according to the above-defined first aspect so that a protection layer between the cathode active material and the solid electrolyte can be omitted. Thus, complexity of the configuration and of the manufacturing process of electrochemical cells is reduced, and the additional ohmic resistance inevitably introduced by a protection layer is omitted.

Preferred composites according to the third aspect as defined herein are those having one or more of the specific and preferred features disclosed above.

A solid material according to the above-defined first aspect resp. obtained by the process according to the above-defined second aspect can be used as a solid electrolyte for an electrochemical cell. Herein the solid electrolyte may form a component of a solid structure for an electrochemical cell, wherein said solid structure is selected from the group consisting of cathode, anode and separator. Accordingly, a solid material according to the above-defined first aspect resp. obtained by the process according to the above-defined second aspect can be used alone or in combination with additional components for producing a solid structure for an electrochemical cell, such as a cathode, an anode or a separator. The substantial absence of undesirable decomposition of the solid electrolyte may remarkably improve the cell performance.

Thus, the present disclosure further provides the use of a solid material according to the above-defined first aspect resp. obtained by the process according to the above-defined second aspect as a solid electrolyte for an electrochemical cell. More specifically, the present disclosure further provides the use of a solid material according to the above-defined first aspect resp. obtained by the process according to the above-defined second aspect as a component of a solid structure for an electrochemical cell, wherein said solid structure is selected from the group consisting of cathode, anode and separator.

In the context of the present disclosure, the electrode of an electrochemical cell where during discharging a net negative charge occurs is called the anode and the electrode of an electrochemical cell where during discharging a net positive charge occurs is called the cathode. The separator electronically separates a cathode and an anode from each other in an electrochemical cell.

The cathode of an all-solid-state electrochemical cell usually comprises a solid electrolyte as a further component beside a cathode active material. Also the anode of an all-solid-state electrochemical cell usually comprises a solid electrolyte as a further component beside an anode active material. Said solid electrolyte may be a solid material according to the above-defined first aspect resp. obtained by the process according to the above-defined second aspect.

The form of the solid structure for an electrochemical cell, in particular for an all-solid-state lithium battery, depends in particular on the form of the produced electrochemical cell itself.

The present disclosure further provides a solid structure for an electrochemical cell, wherein the solid structure is selected from the group consisting of cathode, anode and separator, wherein the solid structure comprises a solid material according to the above-defined first aspect resp. obtained by the process according to the above-defined second aspect. More specifically, the solid structure for an electrochemical cell may be a cathode comprising a composite according to the above-defined third aspect.

The present disclosure further provides an electrochemical cell comprising a solid material according to the above-defined first aspect resp. obtained by the process according to the above-defined second aspect. In said electrochemical cell, the solid material according to the above-defined first aspect resp. obtained by the process according to the above-defined second aspect may form a component of one or more solid structures selected from the group consisting of cathode, anode and separator. More specifically, there is provided an electrochemical cell as defined above wherein in certain preferred cases a solid material according to the above-defined first aspect resp. obtained by the process according to the above-defined second aspect may be in direct contact with a cathode active material having a redox potential of 4 V or more, preferably of 4.5 V or more vs. Li/Li⁺.

The above-defined electrochemical cell may be a rechargeable electrochemical cell comprising the following constituents
α) at least one anode,
β) at least one cathode,
γ) at least one separator,
   wherein at least one of the three constituents is a solid structure (selected from the group consisting of cathode, anode and separator) comprising a solid material according to the above-defined first aspect resp. obtained by the process according to the above-defined second aspect.

Suitable cathode active materials (electrochemically active cathode materials) and suitable anode active materials (electrochemically active anode materials) are known in the art. Exemplary cathode active materials are disclosed above in the context of the third aspect. In an electrochemical cell as described above the anode α) may comprise graphitic carbon, metallic lithium or a metal alloy comprising lithium as the anode active material. Electrochemical cells as described above may be alkali metal containing cells, especially lithium-ion containing cells. In lithium-ion containing cells, the charge transport is effected by Li⁺ ions.

The electrochemical cell may have a disc-like or a prismatic shape. The electrochemical cell can include a housing that can be made of steel or aluminum.

A plurality of electrochemical cells as described above may be combined to an all-solid-state battery, which has both solid electrodes and solid electrolytes. A further aspect of the present disclosure refers to batteries, more specifically to an alkali metal ion battery, in particular to a lithium ion battery comprising at least one electrochemical cell as described above, for example two or more electrochemical cells as described above. Electrochemical cells as described above can be combined with one another in alkali metal ion batteries, for example in series connection or in parallel connection. Series connection is preferred.

The electrochemical cells resp. batteries described herein can be used for making or operating cars, computers, personal digital assistants, mobile telephones, watches, camcorders, digital cameras, thermometers, calculators, laptop BIOS, communication equipment or remote car locks, and stationary applications such as energy storage devices for power plants. A further aspect of the present invention is a method of making or operating cars, computers, personal digital assistants, mobile telephones, watches, camcorders, digital cameras, thermometers, calculators, laptop BIOS, communication equipment, remote car locks, and stationary applications such as energy storage devices for power plants by employing at least one inventive battery or at least one inventive electrochemical cell.

A further aspect of the present disclosure is the use of the electrochemical cell as described above in motor vehicles, bicycles operated by electric motor, robots, aircraft (for example unmanned aerial vehicles including drones), ships or stationary energy stores.

The present disclosure further provides a device comprising at least one inventive electrochemical cell as described above. Preferred are mobile devices such as are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The invention is illustrated further by the following examples which are not limiting.

### EXAMPLES

### 1 Preparation of Solid Materials

Solid materials according to the first aspect of the invention having a composition according to general formula (Ia) were prepared by a thermochemical solid-state process as described above. Reaction mixtures consisting of the precursors
(1) LiCl
(2) YbCl₃
(3) ZrCl₄
   in the proportions to obtain the compositions indicated in table 1 were prepared by uniformly mixing the precursors (1), (2) and (3) using a mortar and pestle in an argon filled glovebox (step a1)). Each reaction mixture was heated-treated at 450° C. in a vacuum sealed quartz tube for 36 hours at 350° C. resp. 650° C. to react the reaction mixture (step 131)), and in each case the obtained reaction product was cooled at a rate of 2° C./min to obtain a solid material in the form of a powder having a composition according to general formula (I) as indicated in table 1.

### 2. Structure Analysis

Powder X-ray diffraction (XRD) measurements of the solid materials obtained as described above were conducted at room temperature using a PANalytical Empyrean diffractometer with Cu-Kα radiation equipped with a PIXcel bidimensional detector. XRD patterns for phase identification were obtained in Debye-Scherrer geometry, with samples sealed in sealed in 0.3 mm glass capillaries under argon.

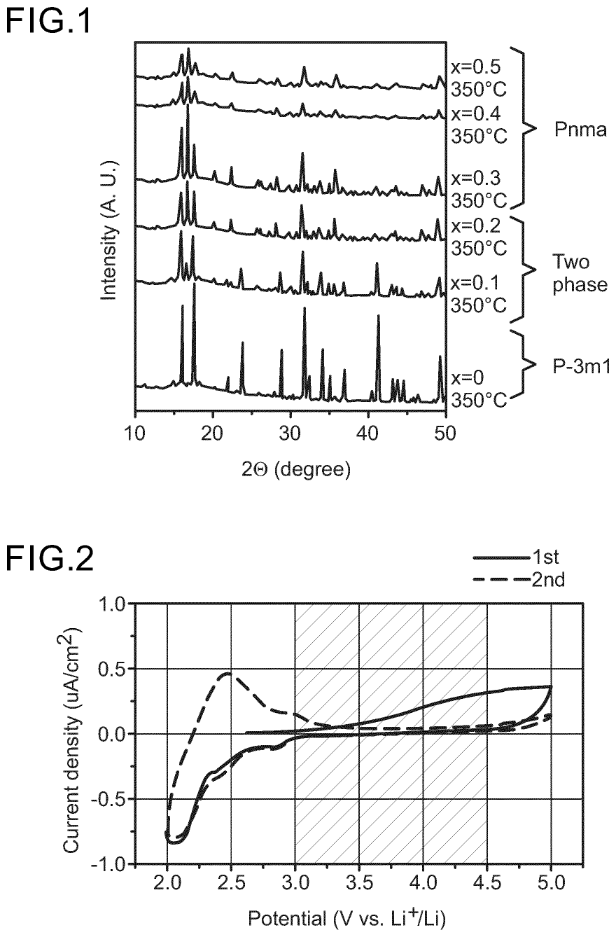

The solid materials obtained as described above were polycrystalline and had little to no impurities as can be derived from the XRD patterns shown in FIG. 1.

FIG. 1 shows the X-ray diffraction (XRD) patterns of Li₃₋ₓZrₓYb₁₋ₓCl₆ materials over the range from x=0 to x=0.5 (cf. table 1 below) obtained by heat treatment at 350° C. The XRD pattern of Li₃YbCl₆ (x=0) corresponds to a previously unreported trigonal structure (space group: P-3m1). The same structure is expected to prevail when 0 <x <0.1. As more Yb³⁺ ions are substituted by Zr⁴⁺ ions (0.1≤x<0.3) a second crystalline phase emerges which has orthorhombic symmetry (Pnma space group), and the mixture is biphasic. When x≥0.3 said second crystalline phase with orthorhombic symmetry (Pnma space group) is present as the only phase.

### 3. Ionic Conductivity

Ionic conductivities of Li₃₋ₓYb₁₋ₓZrₓCl₆ (0≤x≤0.8) samples in the form of pellets were determined by the AC impedance technique using a cell configuration having ionically blocking Ti electrodes: Ti|Li₃₋ₓYb₁₋ₓZrₓCl₆|Ti. The pellets were pressed at 374 MPa. Nyquist plots were recorded at a frequency range of 1 MHz-1 Hz using a MTZ-35 impedance analyzer (Bio-logic). The lithium ion conductivity at 25° C. and the activation energy determined in the usual manner from the conductivity as a function of the temperature according to the Arrhenius equation

σ_{T}=A_{T} exp(−Eₐ/k_{B}T)

(where σ_{T} is the ionic conductivity at the temperature T, T is the temperature in K, A_{T} the pre-exponential factor, Eₐ the activation energy and k_{B} the Boltzmann constant) of all materials is given in table 1 below.

TABLE 1

| | Temperature of | Ionic | Activation |
|---|---|---|---|
| x in | heat treatment | conductivity at | Energy |
| Li₃₋ₓYb₁₋ₓZrₓCl₆ | in step (b1)/[° C.] | 25° C. (S/cm) | (eV) |
| 0 | 350 | 1.0 × 10⁻⁴ | 0.50 |
| 0 | 650 | 6.28 × 10⁻⁴ | 0.61 |
| 0.1 | 350 | 6.1 × 10⁻⁴ | 0.39 |
| 0.2 | 350 | 1.08 × 10⁻³ | 0.32 |
| 0.3 | 350 | 1.04 × 10⁻³ | 0.30 |
| 0.3 | 650 | 8.98 × 10⁻⁴ | 0.35 |
| 0.4 | 350 | 1.08 × 10⁻³ | 0.31 |
| 0.5 | 350 | 1.1 × 10⁻³ | 0.32 |
| 0.5 | 650 | 8.38 × 10⁻⁴ | 0.31 |
| 0.8 | 350 | 3.8 × 10⁻⁴ | 0.35 |

Table 1 shows that the ionic conductivity increases when Yb is partly substituted by Zr while after passing a plateau around 0.2≤x≤0.5. Further substitution of Yb by Zr does not result in a further increase of the ionic conductivity.

### 4. Electrochemical Tests

For the electrochemical tests, composites were prepared by mixing LiCoO₂ (a common cathode active material) and Li₃₋ₓYb₁₋ₓZrₓCl₆ (x=0.3) in a weight ratio of 80:20. The working electrode was formed by spreading the as-prepared electrode composite (10 mg) on a layer of Li₃PS₄ pellet (50 mg). A Li—In alloy was used as a counter electrode. All assembly was carried out in a poly(aryl-ether-ether-ketone (PEEK) mold (diameter: 10 mm) with two Ti rods as the current collectors pressed at 374 MPa before conducting electrochemical tests. The resulting all solid state cell has the configuration

(mixture of LiCoO₂ Li_{2.7}Yb_{2.7}Zr_{0.3}Cl₆)|Li₃PS₄|Li—In alloy.

A cyclic voltammogram of an all-solid-state cell having the above-defined configuration is shown in FIG. 2. The scan rate was 1 mV s⁻¹. In the first scan a broad oxidation peak occurs in the voltage range ≥3.5 V vs Li/Li⁺ while in the second scan there is no significant anodic current in the potential range of from about 3.3 V vs Li/Li⁺ up to about 4.7 V vs Li/Li⁺. It is apparent that in the first cycle the interface between Li₃PS₄ and the working electrode has stabilized, likely owing to formation of a passivation layer, and the Li₃₋ₓYb₁₋ₓZrₓCl₆ (x=0.3) present in the working electrode virtually exhibits electrochemical oxidation stability in contact with a cathode active material LiCoO₂.

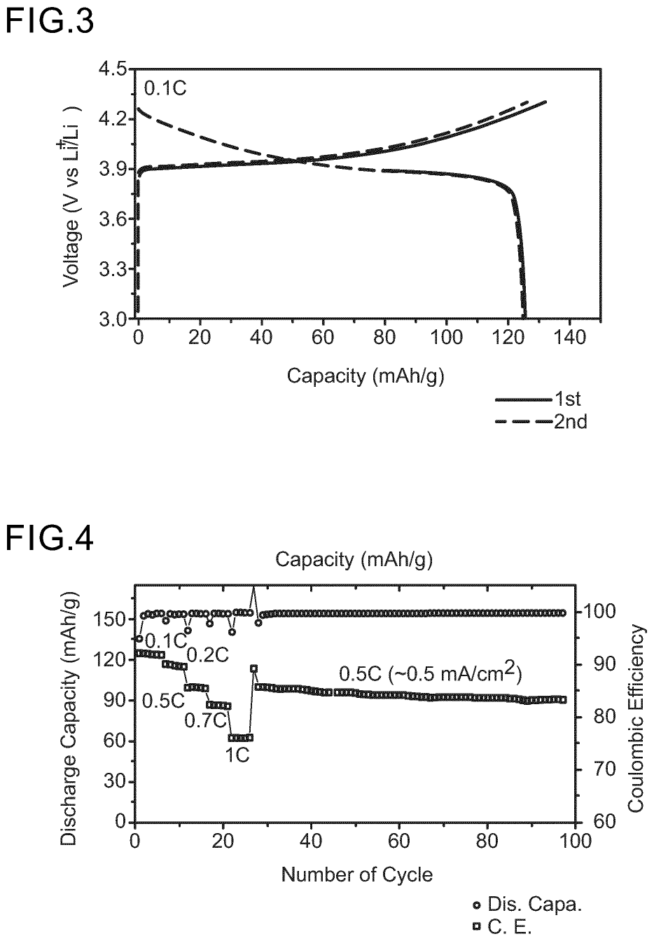

FIG. 3 shows the first (solid lines) and second (dashed lines) charge-discharge profiles (0.1 C) of the above-defined all-solid-state cells having the configuration

(mixture of LiCoO₂ and Li_{2.7}Yb_{0.7}Zr_{0.3}Cl₆)|Li₃PS₄|Li—In alloy.

The cell exhibits a discharge capacity more than 120 mAh g⁻¹. No oxidative side reaction occurred prior to Li⁺ de-intercalation. The second profile does not significantly differ from the first profile, i.e. charge/discharge occurs almost reversible.

FIG. 4 shows the charge-discharge capacity as a function of cycle number at different C-rates. The cell exhibits high coulombic efficiency and good capacity retention.

1. A solid material having a composition according to general formula (I)
Li_{3-n*x}Yb₁₋ₓMₓX_{y} (I)
wherein
0.05≤x≤0.95;
5.8≤y≤6.2;
n is the difference between the valencies of M and Yb;
M is one or more selected from the group consisting of Ti, Zr, Hf, V, Nb and Ta;
X is one or more selected from the group consisting of halides and pseudohalides.

2. The solid material according to claim wherein
0.08≤x≤0.85, and/or
wherein 5.85≤y≤6.15.

3. The solid material according to claim 1, wherein the solid material is crystalline and comprises one or more crystalline phases having a structure selected from an orthorhombic structure in space group Pnma, and a trigonal structure in the space group P-3m1.

4. The solid material according to claim 1, wherein
M is one or more of Ti, Zr, or Hf, and/or
X is one or more selected from the group consisting of Cl, Br and I.

5. The solid material according to claim 1, wherein
M is Zr and
X is Cl.

6. A composite comprising
a solid material according to claim 1 and
and a cathode active material, wherein the cathode active material comprises one or more compounds of formula (II):
Li₁₋ₜ[CoₓMn_{y}Ni_{z}Mᵤ]₁₋ₜO₂ (II)
wherein
0≤x≤1
0≤y≤1
0≤z≤1
0≤u≤0.15
M if present is one or more elements selected from the group consisting of Al, Mg, Ba, B, and transition metals other than Ni, Co, and Mn,
x+y+z>0
x+y+z+u=1
−0.05≤t≤0.2.

7. The composite according to claim 6, wherein the solid material according to claim 1 and the cathode active material are admixed with each other.

8. The composite according to claim wherein the solid material according to claim 1 is present in the form of a coating on the cathode active material.

9. The process for preparing a solid material as defined in claim 1, the process comprising:
(a) providing the precursors
(1) one or more compounds selected from the group consisting of halides and pseudohalides of Li;
(2) one or more compounds selected from the group consisting of halides and pseudohalides of Yb;
(3) one or more compounds selected from the group consisting of halides and pseudohalides of elements M selected from the group consisting of Ti, Zr, Hf, V, Nb and Ta;
wherein in the reaction mixture the molar ratio of Li, Yb, M, halides and pseudohalides matches general formula (I)
(b) reacting the precursors to obtain a solid material having a composition according to general formula (I).

10. The process according to claim 9, wherein the precursors are
(1) one or more compounds LiX
(2) one or more compounds YbX₃
(3) one or more compounds MX₄
wherein
M is selected from the group consisting of Ti, Zr, and Hf, and/or
X is selected from the group consisting of Cl, Br and I.

11. The process according to claim 9, comprising
(a1) preparing or providing a solid reaction mixture comprising the precursors (1), (2) and (3)
(b1) heat-treating the reaction mixture in a temperature range of from 300° C. to 650° C. for a total duration of 5 hours or more so that a reaction product is formed and cooling the reaction product so that a solid material having a composition according to general formula (I) is obtained.

12. The process according to claim 9, comprising
(a2) preparing or providing a liquid reaction mixture by dissolving the precursors (1), (2) and (3) in a solvent selected from the group consisting of ethers, H₂O, alcohols CₙH₂ₙ₊₁OH wherein 1≤n≤20, formic acid, acetic acid, dimethylformamide, N-methylformamide, pyridine, nitriles, N-methylpyrrolidinone, dimethyl sulfoxide, acetone, ethyl acetate, dimethoxyethane, 1,3-dioxolane, and alkylene carbonates;
(b2) removing the solvents from the liquid reaction mixture, so that a solid residue is obtained, and heat-treating the solid residue in a temperature range of from 100° C. to 300° C. for a total duration of 4 hours to 24 hours so that a reaction product is formed and cooling the reaction product so that a solid material having a composition according to general formula (I) is obtained.

13. A solid structure for an electrochemical cell, comprising a solid material according to claim 1 or a composite according to claim 6, wherein the solid structure is selected from the group consisting of cathode, anode and separator.

14. An electrochemical cell comprising a solid material according to claim 1 or a composite according to claim 6.

15. The electrochemical cell according to claim 14, wherein the solid material according to claim 1 or a composite according to claim 6 is a component of a solid structure as defined in claim 13.
